(19) United States
(12) Patent Application Publication
(10) Pub. No.: US 2011/0113049 A1
(43) Pub. Date: May 12, 2011

(54) Anonymization of Unstructured Data

(75) Inventors: Matthew A. Davis, San Jose, CA (US); Daniel F. Gruhl, San Jose, CA (US)

(73) Assignee: INTERNATIONAL BUSINESS MACHINES CORPORATION, Armonk, NY (US)

(21) Appl. No.: 12/614,554

(22) Filed: Nov. 9, 2009

(51) Int. Cl. G06F 17/30

(52) U.S. Cl. 707/757; 707/E17.033

(57) ABSTRACT

A method for anonymization of unstructured data comprises determining structured references in the unstructured data; populating a table with the structured references; anonymizing the structured references in the table using ontological analysis; and rewriting the structured references in the unstructured data with the anonymized structured references from the table to produce anonymized data. A system for anonymizing unstructured data comprises an entity spotting module configured to determine structured references in the unstructured data and populate a table with the determined structured references; an anonymization module configured to anonymizing the structured references in the table using ontological analysis; and a replacement module configured to rewrite the structured references in the unstructured data with the anonymized structured references from the table to produce anonymized data.

### BACKGROUND

This disclosure relates generally to the field of anonymization of unstructured data.

Medical records may comprise a structured portion, including charts or tables with fields for specific types of data, and an unstructured portion, which may contain notes regarding any aspect of a patient's condition. The unstructured portion may include textual data, such as dictation transcripts, or typed or freehand notes. While a medical professional, such as a doctor or nurse, may fail to correctly fill in fields on a chart or table, he or she is likely to correctly note the important features of a patient's visit in the unstructured portion of the patient's medical records, as the unstructured portion may be skimmed to remind him or her of the patient's status before subsequent patient visits.

The unstructured portion of medical records may be an important source of information for compilation of public health statistics. However, such notes are difficult to release, as the Health Insurance Portability and Accountability Act (HIPAA) §1171(6) states that, in the interest of protecting patients, no important information relating to a past, present, or future medical or health condition may be released by an entity covered by HIPAA if the information allows identification of a specific patient. Manual review of unstructured medical records to remove information that may be used to identify a specific patient is not an ideal solution, as manual review may be extremely time consuming, due to the sheer volume of medical records.

### SUMMARY

An exemplary embodiment of a method for anonymization of unstructured data comprises determining structured references in the unstructured data; populating a table with the structured references; anonymizing the structured references in the table using ontological analysis; and rewriting the structured references in the unstructured data with the anonymized structured references from the table to produce anonymized data.

An exemplary embodiment of a computer program product comprising a computer readable storage medium containing computer code that, when performed by a computer, implements a method for anonymizing unstructured data, comprises determining structured references in the unstructured data; populating a table with the structured references; anonymizing the structured references in the table using ontological analysis; and rewriting the structured references in the unstructured data with the anonymized structured references from the table to produce anonymized data.

An exemplary embodiment of a system for anonymizing unstructured data comprises an entity spotting module configured to determine structured references in the unstructured data and populate a table with the determined structured references; an anonymization module configured to anonymizing the structured references in the table using ontological analysis; and a replacement module configured to rewrite the structured references in the unstructured data with the anonymized structured references from the table to produce anonymized data.

Additional features are realized through the techniques of the present exemplary embodiment. Other embodiments are described in detail herein and are considered a part of what is claimed. For a better understanding of the features of the exemplary embodiment, refer to the description and to the drawings.

### BRIEF DESCRIPTION OF THE SEVERAL VIEWS OF THE DRAWINGS

Referring now to the drawings wherein like elements are numbered alike in the several figures:

FIG. 1 illustrates an embodiment of a method for anonymization of unstructured data.

FIG. 2 illustrates an embodiment of a pre-anonymization table (PAT).

FIG. 3 illustrates an embodiment of a taxonomy.

FIG. 4 illustrates an embodiment of a system for anonymization of unstructured data.

FIG. 5 illustrates an embodiment of a computer that may be used in conjunction with systems and methods for anonymization of unstructured data.

### DETAILED DESCRIPTION

Embodiments of systems and methods for anonymization of unstructured data, which may include but is not limited to unstructured medical records, or census data, are provided, with exemplary embodiments being discussed below in detail. Anonymization allows release of unstructured textual medical data for, for example, compilation of health statistics, while protecting patients. Domain ontology-driven entity extraction and anonymization analysis may be used to sanitize unstructured data to comply with regulations for release.

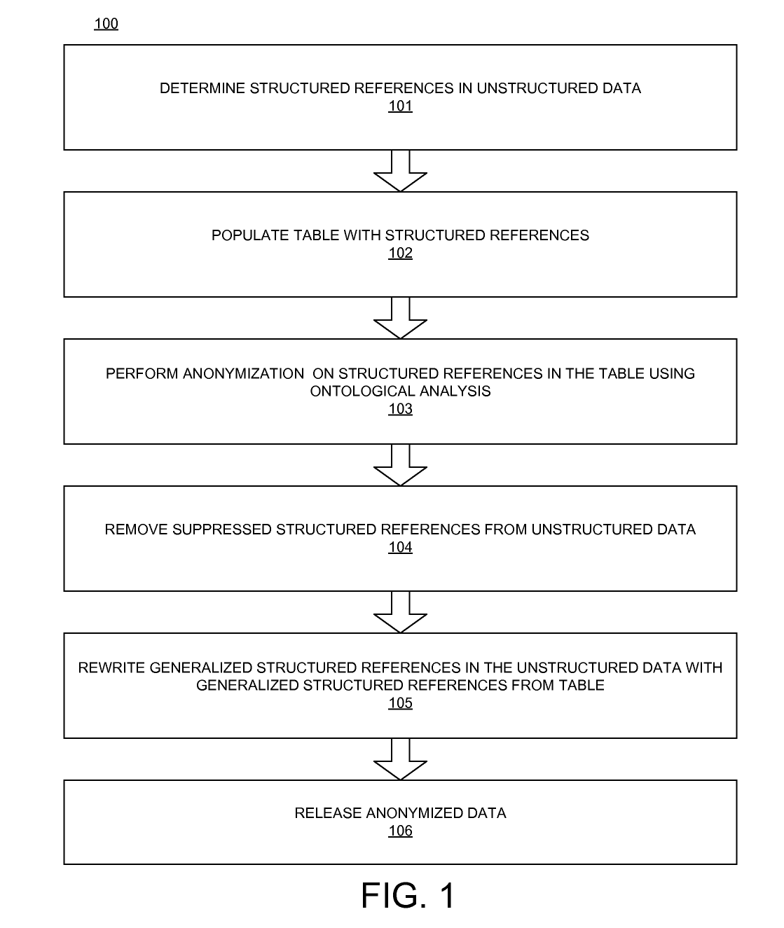

FIG. 1 illustrates an embodiment of a method for anonymization of unstructured data. In block 101, text analysis and entity spotting are performed on the unstructured data to determine structured references contained in the unstructured data. The unstructured data may include but is not limited to unstructured medical information. A structured reference may comprise any term that may be of interest, including diseases, conditions, features, or patient demographics. A structured reference may also include a name or nickname of a patient, or a description of life or job conditions. Any information which may be used to determine an identity of a specific patient may be a structured reference, along with HIPAA required strings, which may include information such as, for example, amputee, fracture, or late term pregnancy.

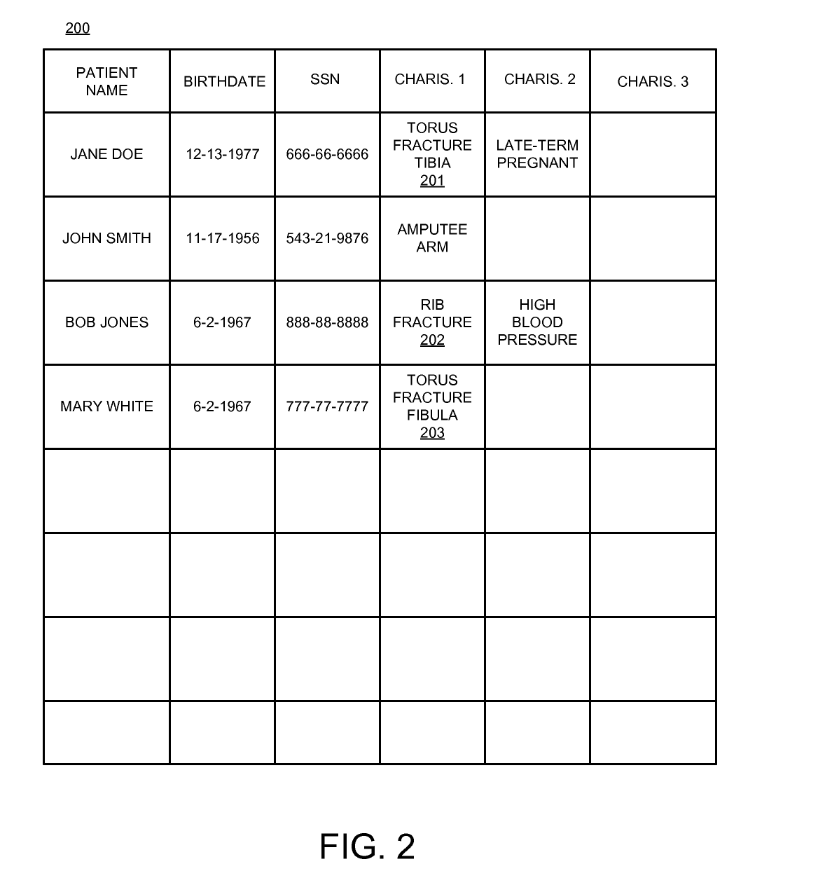

In block 102, structured references determined in block 101 are gathered into a table, which may be referred to as a pre-anonymization table (PAT). An example embodiment of a PAT 200 is shown in FIG. 2. The PAT 200 contains links between each structured reference in the PAT and the location of the structured reference in the unstructured data. The data shown in PAT 200 is for exemplary purposes only; any amount or type of data from the unstructured data may be placed in a PAT.

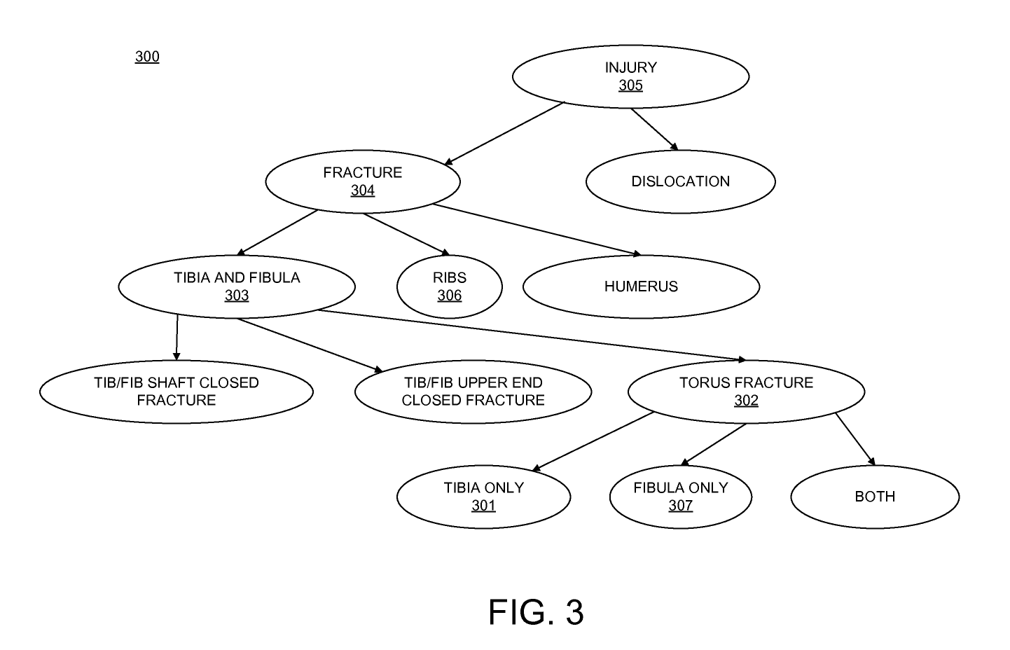

In block 103, the PAT is anonymized to a desired level of anonymization. K-anonymization may be used in some embodiments. In k-anonymization, a threshold, or k-requirement, may be set, defining a minimum number of members of a group that must have a given characteristic. If an insufficient number of members of the group possess a particular characteristic, potentially allowing members of the group to be identified, the characteristic may either be generalized or suppressed. Patient characteristics that cannot be generalized, such as social security number or name, may be suppressed, i.e., removed from consideration for release. A characteristic may be generalized by replacing the term used for the characteristic in the unstructured data with a more general term determined using ontological analysis, which defines relationships between concepts. In some embodiments, ontological analysis may include use of a taxonomy. An embodiment of a taxonomy 300 is shown in FIG. 3. A taxonomy is a hierarchy of terms that may be used to determine a more general term for a given term. Each level up the taxonomy provides a broader term for a given term, thereby anonymizing the information given by a spotted entity. For example, structured reference 201 in the PAT falls into the category of a torus fracture of the tibia 301. Structured reference 201 may be generalized using taxonomy 300 to a torus fracture 302, a tibia and fibula fracture 303, a fracture 304, or an injury 305, depending on the degree of anonymization desired. Structured reference 203 falls into the category torus fracture of the fibula 307, and may also be generalized to a torus fracture 302, a tibia and fibula fracture 303, a fracture 304, or an injury 305. Structured reference 202 falls into category 306 (rib fracture) of taxonomy 300, and may be generalized to fracture 304 or injury 305. In this example, structured references 201 and 202 may be generalized to a torus fracture 302 to meet a k-requirement of 2, or structured references 201, 202, and 203 may all be generalized to fracture 304 to meet a k-requirement of 3. Example medical taxonomies that may be used include but are not limited to the Systemized Nomenclature of Medicine (SNOMED; see http://www.nlm.nih.gov/research/umls/Snomed/snomed_main.html for more information), ICD9, and ICD10. Suppression and generalization may be performed on the data in the PAT until all groups of characteristics in the PAT satisfy the given k-requirement.

Some embodiments may use various refined approaches to k-anonymization. Multidimensional k-anonymization (see K. LeFevre, D. J. Dewitt, and R. Ramakrishnan, Mondiran Multidimensional K-anonimity, Proc. Of ICDE, 2006, for more information) is a technique that may be used in some embodiments. Multidimensional k-anonymization looks at value vectors of quasi-identifier attributes to find correlations across the entire data set, allowing fine-grained generalizations while reducing the number of suppressed rows. P-sensitive k-anonimity (see T. M. Truta and B Vinay, Protection: P-sensitive K-anonimity Property, Proc. Of ICDE, 2006, for more information) may be used in other embodiments, adding an additional layer of protection for confidential attributes, such as income or health conditions, which are not part of the quasi-identifier defined by standard k-anonymization. The definition requires a minimum of p unique groupings be represented in the table for confidential attributes, in addition to the k-requirement for quasi-identifier attributes. I-diversity (see A Machanavajjhala, J. Gehrke, and D. Kifer, I-diversity: beyond K-anonimity, Proc. Of ICDE, 2006, for more information) is another approach; in 1-diversity, attacking based on confidential attributes using existing background knowledge is performed. The confidential attribute values are diversified before release.

Once anonymization is completed in block 103, flow proceeds to block 104, where any structured references that have been suppressed are removed from the unstructured data. In block 105, sentences in the unstructured data that contain generalized structured references are rewritten using the generalized forms determined in block 103. The unstructured data is now anonymized, and may be released in block 106.

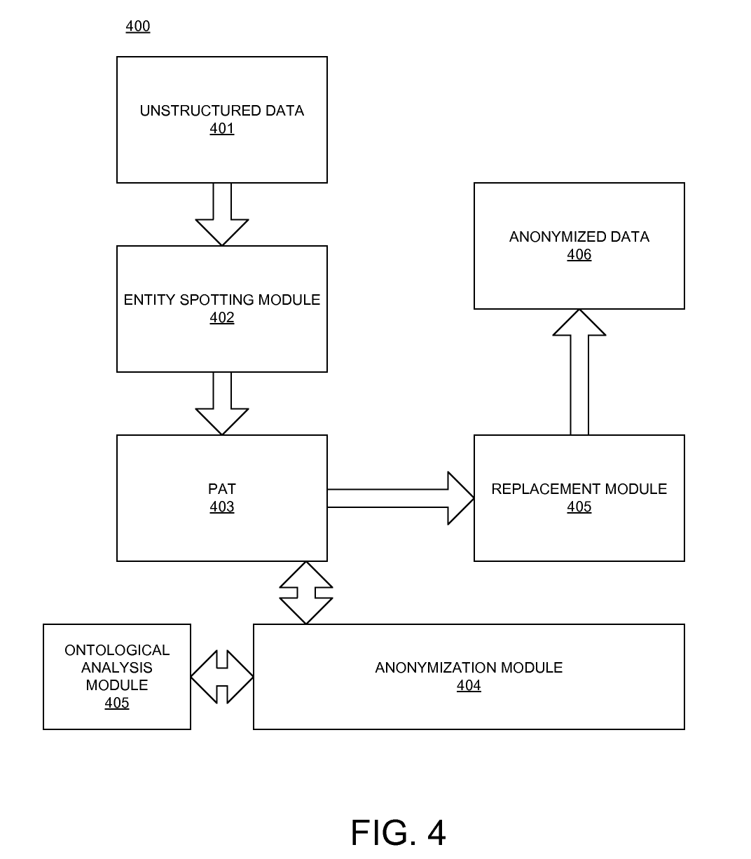

FIG. 4 illustrates an embodiment of a system for anonymization of unstructured data 401. Entity spotting module 402 determined structured references contained in unstructured data 401. Structured references are placed in PAT 403, along with links between the structured references and their location in the unstructured data 401. Anonymization module 404 performs anonymization on PAT 403, using ontological analysis module 405, which may in some embodiments include a taxonomy. Structured references in PAT 403 may be generalized or, if a structured reference cannot be generalized, the structured reference is suppressed. When anonymization is complete, replacement module 405 removes suppressed structured references and rewrites generalized structured references in unstructured data 401 using the links between the structured references in the PAT 403 and the locations of the structured references in unstructured medical data 401, resulting in anonymized data 406. Anonymized data 406 is suitable for release.

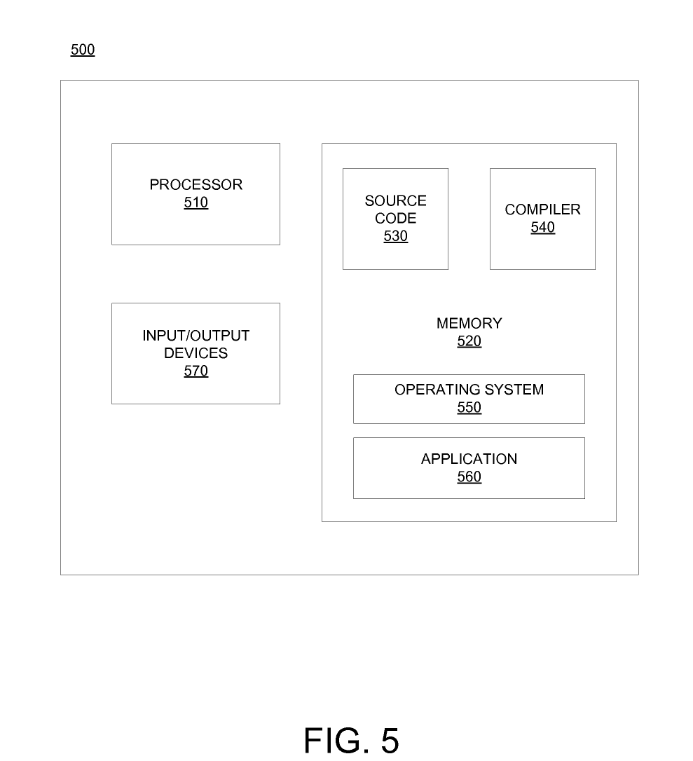

FIG. 5 illustrates an example of a computer 500 having capabilities, which may be utilized by exemplary embodiments of systems and methods for anonymization of unstructured data as embodied in software. Various operations discussed above may utilize the capabilities of the computer 500. One or more of the capabilities of the computer 500 may be incorporated in any element, module, application, and/or component discussed herein.

The computer 500 includes, but is not limited to, PCs, workstations, laptops, PDAs, palm devices, servers, storages, and the like. Generally, in terms of hardware architecture, the computer 500 may include one or more processors 510, memory 520, and one or more input and/or output (I/O) devices 570 that are communicatively coupled via a local interface (not shown). The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 510 is a hardware device for executing software that can be stored in the memory 520. The processor 510 can be virtually any custom made or commercially available processor, a central processing unit (CPU), a data signal processor (DSP), or an auxiliary processor among several processors associated with the computer 500, and the processor 510 may be a semiconductor based microprocessor (in the form of a microchip) or a macroprocessor.

The memory 520 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cassette or the like, etc.). Moreover, the memory 520 may incorporate electronic, magnetic, optical, and/or other types of storage media. Note that the memory 520 can have a distributed architecture, where various components are situated remote from one another, but can be accessed by the processor 510.

The software in the memory 520 may include one or more separate programs, each of which comprises an ordered listing of executable instructions for implementing logical functions. The software in the memory 520 includes a suitable operating system (O/S) 550, compiler 540, source code 530, and one or more applications 560 in accordance with exemplary embodiments. As illustrated, the application 560 comprises numerous functional components for implementing the features and operations of the exemplary embodiments. The application 560 of the computer 500 may represent various applications, computational units, logic, functional units, processes, operations, virtual entities, and/or modules in accordance with exemplary embodiments, but the application 560 is not meant to be a limitation.

The operating system 550 controls the performance of other computer programs, and provides scheduling, input-output control, file and data management, memory management, and communication control and related services. It is contemplated by the inventors that the application 560 for implementing exemplary embodiments may be applicable on all commercially available operating systems.

Application 560 may be a source program, executable program (object code), script, or any other entity comprising a set of instructions to be performed. When a source program, then the program is usually translated via a compiler (such as the compiler 540), assembler, interpreter, or the like, which may or may not be included within the memory 520, so as to operate properly in connection with the O/S 550. Furthermore, the application 560 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, .NET, and the like.

The I/O devices 570 may include input devices such as, for example but not limited to, a mouse, keyboard, scanner, microphone, camera, etc. Furthermore, the I/O devices 570 may also include output devices, for example but not limited to a printer, display, etc. Finally, the I/O devices 570 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 570 also include components for communicating over various networks, such as the Internet or intranet.

If the computer 500 is a PC, workstation, intelligent device or the like, the software in the memory 520 may further include a basic input output system (BIOS) (omitted for simplicity). The BIOS is a set of essential software routines that initialize and test hardware at startup, start the O/S 550, and support the transfer of data among the hardware devices. The BIOS is stored in some type of read-only-memory, such as ROM, PROM, EPROM, EEPROM or the like, so that the BIOS can be performed when the computer 500 is activated.

When the computer 500 is in operation, the processor 510 is configured to perform software stored within the memory 520, to communicate data to and from the memory 520, and to generally control operations of the computer 500 pursuant to the software. The application 560 and the O/S 550 are read, in whole or in part, by the processor 510, perhaps buffered within the processor 510, and then performed.

When the application 560 is implemented in software it should be noted that the application 560 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 560 can be embodied in any computer-readable medium for use by or in connection with an instruction performance system, apparatus, or device, such as a computer-based system, processor-containing system, or other system that can fetch the instructions from the instruction performance system, apparatus, or device and perform the instructions. In the context of this document, a “computer-readable medium” can be any means that can store, communicate, propagate, or transport the program for use by or in connection with the instruction performance system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 560 is implemented in hardware, the application 560 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The technical effects and benefits of exemplary embodiments include anonymizing of unstructured medical data for release, so as to conform to laws and policies protecting patients while gathering important public health data.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for anonymization of unstructured data, the method comprising:
determining structured references in the unstructured data;
populating a table with the structured references;
anonymizing the structured references in the table using ontological analysis; and
rewriting the structured references in the unstructured data with the anonymized structured references from the table to produce anonymized data.

2. The method of claim 1, wherein the unstructured data comprises unstructured medical records.

3. The method of claim 1, wherein anonymizing the structured references comprises k-anonymizing the structured references, and using ontological analysis comprises using a taxonomy.

4. The method of claim 1, wherein anonymizing the structured references further comprises suppressing structured references that cannot be generalized.

5. The method of claim 4, wherein a suppressed structured reference comprises one of a social security number, a patient nickname, or a patient name.

6. The method of claim 4, further comprising removing the suppressed structured references from the unstructured data.

7. The method of claim 1, further comprising releasing the anonymized data.

8. The method of claim 1, wherein a structured reference comprises a string required by the Health Insurance Portability and Accountability Act (HIPAA).

9. The method of claim 1, wherein a structured reference comprises one of a disease, a condition, a patient feature, a job of the patient, or a patient demographic.

10. The method of claim 1, wherein the table comprises a link between a structured reference and a location of the structured reference in the unstructured data.

11. A computer program product comprising a computer readable storage medium containing computer code that, when performed by a computer, implements a method for anonymizing unstructured data, wherein the method comprises:
determining structured references in the unstructured data;
populating a table with the structured references;
anonymizing the structured references in the table using ontological analysis; and
rewriting the structured references in the unstructured data with the anonymized structured references from the table to produce anonymized data.

12. The computer program product of claim 11, wherein the unstructured data comprises unstructured medical records.

13. The computer program product of claim 11, wherein anonymizing the structured references comprises k-anonymizing the structured references, and using ontological analysis comprises using a taxonomy.

14. The computer program product of claim 11, wherein anonymizing the structured references further comprises suppressing structured references that cannot be generalized.

15. The computer program product of claim 11, further comprising releasing the anonymized data.

16. The computer program product of claim 11, wherein a structured reference comprises a string required by the Health Insurance Portability and Accountability Act (HIPAA).

17. The computer program product of claim 11, wherein the table comprises a link between a structured reference and a location of the structured reference in the unstructured data.

18. A system for anonymizing unstructured data, the system comprising:
an entity spotting module configured to determine structured references in the unstructured data and populate a table with the determined structured references;
an anonymization module configured to anonymizing the structured references in the table using ontological analysis; and
a replacement module configured to rewrite the structured references in the unstructured data with the anonymized structured references from the table to produce anonymized data.

19. The system of claim 18, wherein the unstructured data comprises unstructured medical records.

20. The system of claim 18, wherein the table comprises a link between a structured reference and a location of the structured reference in the unstructured data.
